(19) United States
(12) Patent Application Publication
(10) Pub. No.: US 2015/0064682 A1
(43) Pub. Date: Mar. 5, 2015

(54) SUPERVISION OF A MOBILE CLASS

(71) Applicant: Societe BIC, Clichy Cedex (FR)

(72) Inventors: Mathias Mattiuzzo, Vincennes (FR); Sylvain Giroudon, Montrouge (FR)

(21) Appl. No.: 14/390,886

(22) PCT Filed: Mar. 26, 2013
(86) PCT No.: PCT/FR2013/050641

§ 371 Date: Oct. 6, 2014

(30) Foreign Application Priority Data
Apr. 6, 2012 (FR) 1253234

(51) Int. Cl. G09B 5/00; G06F 3/041

(52) U.S. Cl. CPC G09B 5/00; G06F 3/041
USPC 434/351

(57) ABSTRACT

A system for providing electronic assistance in teaching. The system includes a plurality of touch tablets (T1, T2, TN), a teaching computer (PC, SRV), and a supervision circuit (SV) arranged to store the touch inputs made on all of the touch tablets and to play them back. In addition, the invention related to a method performed by the system, to a computer program for performing the above-specified method, and to a data medium including such a computer program.

### CROSS REFERENCE TO RELATED APPLICATIONS

This application is a national stage application of International Application No. PCT/FR2013/050641, filed on Mar. 26, 2013, which claims the benefit of French Patent Application No. 1253234, filed on Apr. 6, 2012, the entire contents of both applications being incorporated herein by reference.

### BACKGROUND OF THE INVENTION

### Field of the Invention

The embodiments of the present invention relate to the field of providing electronic assistance in teaching, in particular teaching young children (nursery school or primary school pupils).

Certain teaching techniques make use of tablets, which are very flat laptop computers with the majority of one of their two main faces being constituted by a screen. These tablets may be constituted in particular by conventional tablets designed for general purpose use (and not specifically for teaching young children).

Such tablets may be touch tablets. They may then be used for writing directly on the screen, either with one or more fingers or else by means of a stylus, which may be preferable in the context of learning how to write since using a stylus is similar to using a pen (or more generally a “writing instrument”).

Nevertheless, existing systems provide for only limited supervision of the activities of pupils. Emphasis is generally put on reusing commercially available generic tablets (that are not dedicated to the field of educating young children). Such tablets are designed more as individual tools than as parts of a set of tools suitable for being supervised collectively by a teacher.

The embodiments of the present invention seeks to improve the situation.

One aspect of the present invention provides an electronic system for providing assistance in teaching, the system comprising:
a plurality of wireless touch tablets each having a user identification circuit;
a teaching computer storing a list of pupils, and arranged to transmit educational content to each wireless touch tablet for which the identified user is a pupil of the list; and
a supervision circuit arranged to store the touch inputs made on all of the wireless touch tablets for which the identified user is a pupil of the list of pupils, which touch inputs are stored in respective files associated with the pupils, the files containing the spatial coordinates of each touch input under consideration as well as a time marker indicating the instant of the touch input, and arranged, upon request from the teaching computer, to play back the educational content transmitted to the touch tablet used by a given pupil in the list of pupils, while simultaneously playing back the results of the touch inputs made on the touch tablet.

This system is advantageous not only in that it enables a class to be supervised, but also in that the quantity of data generated for the supervision is small, thereby saving on bandwidth. In particular, when about thirty tablets are simultaneously in communication over the wireless network, it is advantageous for use of the radio resources to be parsimonious. The system is also advantageous in that it makes it possible to save on storage space. The supervision of the class made possible by this system improves the interactivity of the teaching.

Another aspect of the embodiments of the present invention relate to a method for providing electronic assistance in teaching, with a system comprising:
a plurality of wireless touch tablets, each including a user identification circuit;
a teaching computer storing a list of pupils and arranged to transmit educational content to each wireless touch tablet for which the user has been identified as a pupil of the list; and
a supervision circuit;
the method comprising:
a) the supervision circuit storing touch inputs performed on every wireless touch tablet which user is identified as a pupil of the list of pupils, which touch inputs are stored in a respective file associated with the pupil, the file containing the spatial coordinates of each touch input under consideration as well as a time marker indicating the instant of the touch input; and
b) on request from the teaching computer, playing back the educational content transmitted to the touch tablet used by a given pupil of the list of pupils, and simultaneously playing back the result of the touch inputs performed on the touch tablet.

This method is advantageous not only in that it enables a class to be supervised, but also in that the quantity of data generated for such supervision is small, thereby saving on bandwidth. The method is also advantageous in that it enables storage space to be saved. The class supervision made possible by this method improves the interactivity of the teaching.

Another aspect of the embodiments of the present invention relate to a computer program having a series of instructions performing the method of an aspect of the present invention when the instructions are executed by one or more processors.

Another aspect of the embodiments of the present invention provide a non-transitory computer readable storage medium including a computer program of an aspect of the present invention.

These programs and storage media provide the advantages of the method together with increased flexibility compared with a purely hardware implementation of the present invention (in particular modifying or updating the system can be made easier).

Other aspects, objects, and advantages of the present invention appear in non-limiting manner on reading the following description of some of its embodiments.

The embodiments of the present invention can also be better understood with the help of drawings, in which:

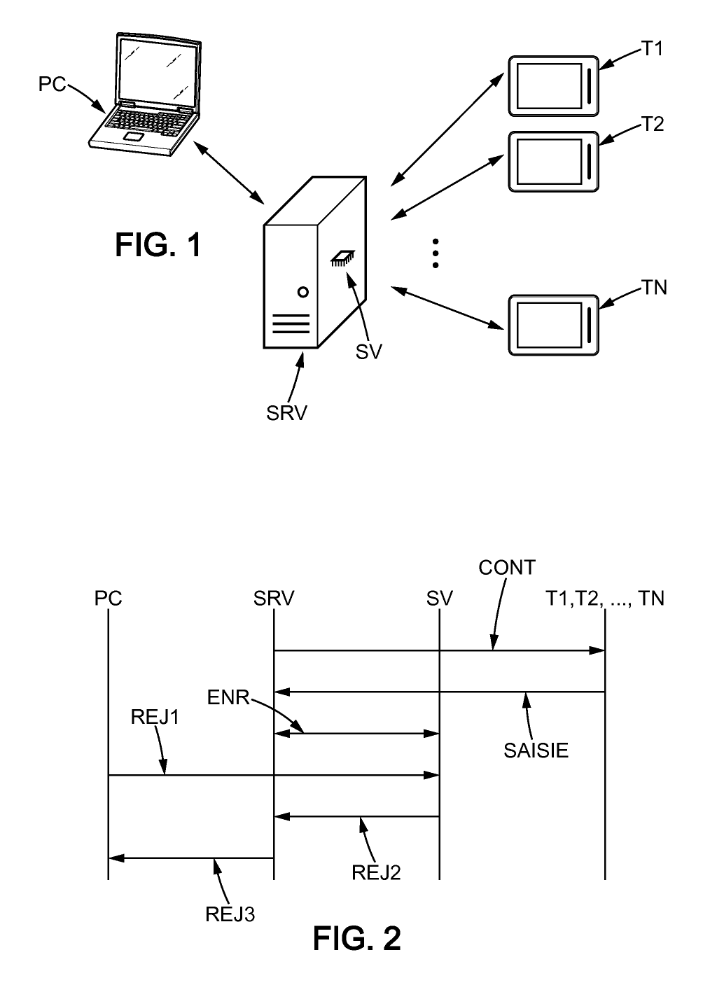

FIG. 1 shows a system according to a possible embodiment; and

FIG. 2 shows various steps of a method according to a possible embodiment.

FIG. 1 shows a system comprising a teaching computer, a set of touch tablets T1, T2, TN, and a supervision circuit SV. The teaching computer comprises a laptop computer PC usable by a teacher that is connected to a server SRV. The server SRV manages the touch tablets, and includes the supervision circuit SV.

A first embodiment relates to an electronic system for providing assistance in teaching.

The system comprises a plurality of wireless touch tablets, each having a user identification circuit.

The system has a teaching computer storing a list of pupils and arranged to transmit educational content to each wireless touch tablet having as its identified user a pupil in the list.

The user identification circuit may be a processor (it may even be a processor that already exists in the tablet, such as a main processor), associated with a memory storing a program suitable for performing identification. The identification circuit may be arranged to verify with the teaching computer that the identifier that has been input does indeed correspond to a pupil in the class. The identification circuit may also be a dedicated electronic circuit, such as an application-specific integrated circuit (ASIC) or a field-programmable gate array (FPGA), or an electronic circuit made entirely to measure, or a dedicated microcontroller. It may also comprise a combination of a component of the tablet together with a component of the teaching computer. The identification circuit may thus obtain a list of pupils stored in the teaching computer from a component of the teaching computer, may present this list on the screen of the touch tablet, and ask the user to click on the user's name. The circuit may also ask the users to write their names (by clicking on displayed letters or by using a keyboard). In one possible embodiment, the identification circuit does no more than display the information transmitted by the teaching computer (e.g. a list of pupils in the form of a transmitted JPEG-format image), leaving the teaching computer to select the user (an index in a list, or the coordinates of a point selected on the screen, etc.).

The teaching computer then itself determines which pupil is concerned (and optionally transfers pupil identification to a component of the identification circuit situated in the tablet). The tablet can thus be interchangeable (and not tied to any particular pupil), and thus each time pupils take tablets for an exercise that needs a tablet, they may very well use different tablets.

The teaching computer may be a conventional laptop personal computer having software that is suitable for the present invention. Instead of being a laptop computer, it could also be a desk computer (having a tower, a separate screen, and a separate keyboard) with suitable software, or any control console that has suitable software installed. The teaching computer may also be made up of a plurality of elements. For example, the teaching computer may be a physical server (storing the list of pupils) associated with a laptop or desk computer providing a teacher with a user interface (the server not necessarily having a screen and a keyboard). The physical server may be in the classroom, e.g. in a docking station, and it may communicate with the desk or laptop computer (which may for example be on the desk of the teacher, in the classroom) by wired communication (Ethernet or other) or by wireless communication (e.g. WiFi).

Each tablet may have a WiFi wireless communications circuit suitable for communicating with the teaching computer (e.g. with the server of the teaching computer when the teaching computer includes such a server) via WiFi communication (or via any other suitable wireless protocol).

The system has a supervisor circuit arranged to store the touch inputs made on all of the wireless touch tablets having a user identified as being a pupil in the list of pupils.

The supervisor circuit stores the touch inputs in a file associated with that pupil, the file including the space coordinates of the touch input under consideration (e.g. the abscissa and ordinate values of the point where the screen was touched, or indeed polar coordinates for that point). The file associated with the pupil also includes a time marker specifying the instant at which the touch input was made (e.g. in the form of the time that has elapsed since the beginning of the exercise, which may be expressed in hundredths of a second, for example). The time maker may also rely on a time reference of the supervisor circuit, of the tablet, or of the teaching computer (these three entities may indeed have a time reference in common, e.g. being synchronized with the help of an external unit such as a server connected to an atomic clock). Thus, the time marker may correspond to the exact time (e.g. to within one hundredth of a second) in the time zone within which the entities are located. The touch input may be the result of touches made on the screen with a stylus (or alternatively direct touches with a finger, even though that is less accurate than a stylus). The touch inputs take place after the tablet has displayed the educational content. They correspond to the pupil interacting with the educational content. The educational content (e.g. in HTML format or in a proprietary format) may be displayed with software installed on the tablet (e.g. a web browser or dedicated software, possibly proprietary software) or it may be contained in an executable file executed by the tablet.

Storing the space coordinates and the time markers is advantageous in particular in that it makes it possible to implement a playback mechanism that is independent of the means used for displaying the educational content. Thus, there is no need to be in a position to determine the meaning of the pupil's input (e.g. there is no need to determine what the pupil is writing, or to determine that the pupil clicked on a particular displayed element from a list of elements, or to determine that the pupil is performing any specific task). It suffices to play back the educational content while simulating the interactions of the pupil (because the pupil's inputs have been stored, there being no need for the system to understand them). Thus, if a new type of educational content is developed and requires new specific software, there is no need to modify the method of storing the space and time coordinates of each input, which system continues to be operational. It suffices to install the new specific software, thereby minimizing problems of integration.

It is possible to store other parameters, such as the force with which the pupil presses on the stylus (or a finger), or the angle of inclination of the stylus, provided the technology of the touch screen and the stylus make that possible. The recording of each input may include additional information, such as a possible change of palette (the “color” of the stylus, i.e. the color that is displayed while the pupil is drawing with the stylus). The additional information may be more particularly pertinent when it does not result directly or indirectly from the pupil's touch input, and when it cannot be determined as a function of that input and of the displayed educational content. Thus, a change in the thickness of the trace drawn, initiated by the pupil clicking on an icon provided for this purpose, may be determined a posteriori solely on the basis of the pupil's input and of the educational content. For example, at the moment of the appropriate input, the displayed content may include an icon for changing line thickness at the location where the pupil has clicked. Nevertheless, certain parameters may be external parameters. For example, the teaching computer may be arranged to intervene on the pupils' tablets. It may in particular intervene in order to change a thickness parameter of the stylus on the screen. Dots may be larger or smaller and lines drawn on the screen may be thicker or thinner, depending on the thickness parameter. If the teacher finds that a pupil with poor eyesight is writing with a line that is too fine, the teacher can thus change the thickness of the lines drawn without moving (from the teaching computer) and even without involving the pupil. By way of example, the teaching computer may also be arranged to change the current color (from among the colors in a suggested palette) used by the pupil without the pupil intervening and without interrupting the pupil's work. The teaching computer may also be arranged to enable such a modification to be made globally (for a predetermined group of pupils or for the entire class). Thus, instead of saying “take your blue pen” and then waiting (possibly for a long time with young children) for all of the pupils to configure their styluses (e.g. by clicking on a blue icon), the teacher can merely configure all of the tablets from the teaching computer so that the touch inputs from the styluses all give rise to blue marks. Under such circumstances, any subsequent touch input carried out by each of the pupils may cause the change of palette or of line thickness (or of any other parameter that has been performed on the tablet from the teaching computer to be stored in the corresponding file associated with each of the pupils). While also storing the coordinates of the input and a time marker (a time stamp for each input), it is also possible to store parameters that can be determined but that are lengthy and/or complex to determine. Thus, instead of performing lengthy calculations on the basis of the transmitted educational content and of the touch inputs in order to determine these parameters, the parameters are stored directly. However it is generally appropriate to decide on including such parameters in the files only after taking into consideration the size of the files and the bandwidth requirements they generate (when such files are exchanged). It is often more appropriate to optimize file size and bandwidth by ignoring such superfluous parameters, even though that can slow down playback processing of the files. Nevertheless, in certain circumstances, for file playback to take place at the same time scale as used while storing input, it may be found that the calculation file of the teaching computer is not sufficient. Instead of requiring a more powerful teaching computer, one option might then consist in transmitting the precalculated parameters so as to avoid the need to have them calculated by the teaching computer.

In an embodiment, the touch inputs of a pupil are obtained by sampling at a frequency lying in the range hertz (Hz) to 100 Hz. Thus, when the stylus (or any other element such as a finger) is not in contact with the screen, no input is stored. However when the stylus (or any other object) is in continuous contact with the screen (e.g. while the pupil is drawing and holding the stylus in a pressed position), up to 100 inputs may be obtained per second (for a sampling frequency of 100 Hz). In an embodiment, a high sampling frequency (such as 100 Hz) is used in order to be able to measure fast movements of the pupil with very good resolution. In an embodiment, decimation or interpolation is performed on the basis of the inputs that are obtained before they are stored. Thus, if the inputs represent a movement that is regular, the supervisor circuit may perform interpolation (e.g. a polynomial interpolation). It can thus select some minimum number of inputs for storing from among all of the inputs obtained given the sampling frequency, e.g. by using the least squares method (or a similar method) to ensure that the difference between the curve interpolated on the basis of these minimum inputs and the curve corresponding to all of the inputs actually obtained is as small as possible (difference smaller than a predetermined threshold). This avoids storing a very large quantity of inputs (such as 700 inputs in a specific example). If made possible by the regularity of the touch inputs (and in particular if the inputs correspond to writing very slowly or very regularly, such as drawing a straight line), the supervisor circuit stores only a small number of inputs (such as 12 inputs in a specific example). These stored inputs may optionally be associated with interpolation information making it possible (during playback) to determine in optimum manner an approximation for all of the inputs actually obtained (but most of which were not stored) on the basis of the few inputs actually stored (e.g. 12 inputs in the above example). Depending on the predetermined threshold, an approximation by interpolation may be indistinguishable to the human eye from the genuine input. This has the potential of very greatly reducing the volume of inputs that are stored, and thus the size of the file.

The supervisor circuit is arranged, on request from the teaching computer, to play back the educational content transmitted to the touch tablet used by a given pupil in the list of pupils, simultaneously together with the result of the touch inputs applied to the same touch tablet. This playback may take place on the teaching computer, thereby emulating the tablet. It may take place after the class, while the teacher is evaluating the work of the pupils or is seeking to understand the difficulties of a pupil. The teacher thus sees what the pupil saw when confronted with the educational content, and the teacher also sees how the pupil interacted with that content, exactly as though the pupil's tablet were being filmed while the pupil was doing the exercise.

The supervisor circuit may form part of the teaching computer or it may be a distinct entity (such as a separate server). The supervisor circuit may be a digital signal processor (DSP).

It may also be a conventional processor (it may even be a processor that already exists in the teaching computer, such as its main processor), associated with memory storing a program suitable for performing the supervision. It may also be a dedicated electronic circuit, such as an ASIC or an FPGA, or an electronic circuit made entirely to measure, or a dedicated microcontroller. It may also be a combination of a component of the tablet and a component of the teaching computer or of a distinct server. In another embodiment, the supervisor circuit may have components in each of the tablets, these components being in charge of supervising the tablets in which they are integrated, and providing a supervision interface with the teaching computer (it may for example be a web interface accessible by using a web browser of the teaching computer).

The educational content is interactive content. In particular, it may comprise exercises to which the pupil is to give answers, e.g. by clicking on the correct answers from among all of the answers suggested, or by coloring a drawing, or by copying lines of writing in accordance with instructions and with the stylus. The supervisor circuit may be arranged to transmit to the teaching computer the educational content that was previously transmitted to the tablet, in the form of an executable file. The educational content may be content executed by the tablet itself, e.g. in the form of an HTML file containing JavaScript code that is processed by a web browser of the tablet, or a PDF file containing JavaScript code. The same content (rather than screen copies of the content) may be retransmitted to the teaching computer.

The content may also be stored within a file that is directly executable by the tablet. The term “directly” means that there is no need to open the file using suitable software in order to execute it, but on the contrary that the file can be executed by the processor of the tablet without calling on any specific software, with the file, while it is being executed and where appropriate (and at its discretion), potentially calling on an operating system of the tablet or on specific pieces of software. In order to trigger execution of the file, it is nevertheless possible to pass via a graphical interface of dedicated software or of an operating system of the tablet.

By way of example, the multimedia file may be a file in the “portable executable” (PE) format, usually having an extension.EXE (where the “extension” of a file specifies the characters following the last dot included in the file name), and appropriate for a tablet having a Microsoft Windows CE operating system. In particular, it may also be a file in the “executable and linkable format” (ELF) having a name that often does not have an extension (the name of a file often does not include a dot) and suitable for a tablet using a Linux operating system, or any other suitable format, depending on the type of tablet.

The teaching computer can then execute this content and simulate the actions of the pupil on the basis of the stored inputs. Thus, software in the teaching computer can open a file (HTML, PDF, etc.) containing the educational content (that may be referred to as the “content file”), that was originally opened by the tablet using a browser or any software suitable for opening such a content file (the content file may for example be a simple text file having no executable code, that the pupil views on the tablet using a text editor and that the pupil has added to in compliance with instructions from the teacher and by using the text editor, e.g. by using a virtual keyboard displayed on the screen, and clicking on selected letters). Alternatively, the teaching computer may execute the content file directly if it is a directly executable file. The teaching computer may then transmit events to the browser (or to other software or to program resulting from executing the content file when the content file is a directly executable file), which events simulate the touch inputs, but are actually recreated artificially from the file associated with the pupil in question.

The content file and the file associated with the pupil may be two distinct files. The file associated with the pupil may be duplicated (e.g. on the tablet and/or on other entities such as the teaching computer) and it may be updated in parallel (with each instance of this file being updated, e.g. in synchronized manner, in real time, or on the contrary once in a while, e.g. at the end of a session). In another embodiment, the file associated with the pupil is in fact a content file that is modified by adding the pupil's inputs (the inputs being represented at least by their space and time coordinates). Under such circumstances, a content file may for example be present initially in the teaching computer (or elsewhere) and then transmitted to the tablet for display (the content file is then duplicated on two distinct computers constituted for example by the tablet and by the teaching computer), and then updated progressively as it receives inputs from the pupil (the system may update both versions of the content file, or only one of them).

The teacher can thus observer how the pupil in question grasps the exercise. In particular, the teacher assesses not only the final result (e.g. the writing of letters and digits) but also the method used for achieving this result. By way of example, the teacher may observe that the pupil is not forming letters and digits (or perhaps only some of them) in the order requested by the teacher. For example, the teacher may observe that when the pupil is forming the digit 8, the pupil begins by drawing a large circle low down and in then a small circle on top, which is not in compliance with the method that is being taught, even though the final result might be satisfactory. By way of example, the teacher may also understand why a pupil is slow or may identify aspects of an exercise where the pupil has spent too much time or has changed an initial answer many times, before deciding on a final answer (whether right or wrong).

In an embodiment, the supervisor circuit is also arranged to supervise a tablet in real time (as well as or as an alternative to storing the pupil's lesson for deferred viewing by the teacher). The supervisor circuit may also transmit the information that is input to the teaching computer. Thus, the teacher can monitor at all times what a pupil is doing from the teaching computer without having to go to the pupil's table.

In an embodiment, the supervisor circuit includes a converter for transforming the file associated with a given pupil (and in combination with the educational content under consideration) into a video in an ordinary recording format such as an MPEG4, DIVX, H264, WMV, or RealVideo format. The teaching computer can thus be used to send parents the work of their children without the parents needing to have any particular software or system suitable for decoding the file associated with a pupil. Clearly a video recording, although easier for the parents of pupils to use, is liable to loose quality associated with video compression, and it occupies a large amount of space compared with storage in accordance with the present invention. Such videos may be recorded on a file server integrated in the teaching computer (or hardware separate from the hardware of the teaching computer that includes the user interface used by the teacher, for example the teacher may have a laptop computer and the file server may be a physical server that is distinct and connected to the laptop computer, so that in combination, together they form the “teaching computer”).

In an embodiment, the supervisor circuit is arranged, on storing too small a number of pertinent touch inputs for a given wireless touch tablet over a period of time longer than a predetermined threshold, to notify this event of insufficient touch inputs to the teaching computer.

It is possible to provide a plurality of thresholds, each suitable for triggering an event notification, depending on the number of touch inputs during a duration associated with each threshold.

In an embodiment, all touch inputs are considered as being pertinent.

In an embodiment, the supervisor circuit notifies an insufficient input event in the event of no interaction at all between the pupil and the tablet (no touch input) when this lack of input exceeds a predetermined duration (e.g. two minutes).

In an embodiment, the supervisor circuit notifies an insufficient input event when the number of touch inputs (of any kind, i.e. all touch inputs are considered a priori as being pertinent) made by the pupil on the tablet is lower than a given value and when this number remains lower than the given value for a duration that exceeds a predetermined duration (e.g. less than three touch inputs during five minutes).

In another embodiment, the supervisor circuit is arranged to identify certain touch inputs as being not pertinent (not to be taken into account when deciding on notifying an insufficient input event). For example, inputs on non-active screen zones may be considered as being not pertinent. A non-active zone is a zone with which no action is associated (other than detecting the input and observing that no action is associated therewith), this touch input then being equivalent to no input from the point of the result it produces. Possibly, inputs that seek to make adjustments (adjusting the brightness of the tablet, adjusting sound volume if the tablet plays sound, possibly via a headset, etc.) may also be considered as non-pertinent inputs. For example, certain inputs seek to cause a text to scroll, to zoom, or to change the orientation of an image, and these inputs may be considered as being non-pertinent inputs. Each educational content may be associated with a particular set of types of input that are considered as being non-pertinent in the context of that educational content.

Thus, in an embodiment, the supervisor circuit notifies a lack of pertinent inputs from the pupil (i.e. the only inputs that might have been identified are excluded as being non-pertinent) when this lack of input exceeds a predetermined duration (e.g. five minutes).

In another embodiment, the supervisor circuit notifies the fact that the number of pertinent inputs from the pupil (i.e. ignoring inputs that are considered as being non-pertinent) during a predetermined input is less than a predetermined value (e.g. less than fifteen pertinent touch inputs in ten minutes). By way of example, this predetermined value may correspond to the mean number of inputs needed to do an average exercise during a period of time, possibly minus a certain percentage. This possible reduction serves to avoid notifying pupils who are a little slow, and who are possibly already known, instead concentrating on those who are really not working enough in order to remedy this lack of work. This embodiment applies particularly well to exercises in which the number of pupil interactions with the tablet (number of touch inputs) is supposed to be distributed in substantially linear manner (e.g. for a series of short questions of uniform complexity).

Thus, the teacher can become aware that such and such a pupil is not working or is working much too slowly even though that might have escaped the teacher's attention if the teacher is preoccupied with other pupils (e.g. disorderly pupils).

A notification by the supervisor circuit may cause the screen of the teaching computer to display a list of active tablets (if that list is not already displayed by default). Each active tablet may be associated with an icon. For example a green icon communicates that the pupil is interacting regularly with the tablet. A yellow icon may indicate that the pupil has not input any information (or any pertinent information, or much too little information or much too little pertinent information, depending on the selected configuration) for a length of time that is longer than a determined threshold (e.g. one minute). A red icon may indicate that some other threshold (e.g. five minutes) has been exceeded during which the pupil has not input any information (or any pertinent information, or much too little information or much too little pertinent information, depending on the configuration selected). The supervisor circuit may send a message to the teaching computer (or may trigger a software interrupt, or use any other appropriate method of notification) in order to inform it of any threshold being crossed by any of the tablets, and update the display. It may cause a particular sound to be issued drawing the attention of the teacher and of the pupil each time a threshold is crossed. This sound may in particular be issued by the tablet of the pupil in question, on the teaching computer, or on both together. This option may be deactivated, e.g. in order to avoid stigmatizing a pupil.

In order to make the display of tablets on the teaching computer more user-friendly, the following provisions may be applied. The tablets may have accelerometers in order to determine their positions in the classroom. At least two accelerometers are needed (one for one horizontal axis and the other for another horizontal axis). It may be advantageous also to have an accelerometer for a vertical axis in order also to measure the height of the tablet (but this is not essential in general). Knowing height can assist in locating a tablet that has temporarily been mislaid (e.g. stored by a person other than the teacher, e.g. a pupil or a classroom cleaner, or by the teacher but not in the right place, for example). It is possible to use a greater number of accelerometers, and it is thus possible to use six accelerometers in order to know its position with more accuracy. It is also possible to provide gyros in order to know the orientation of each tablet, but (in general) this is not essential in this context.

The supervisor circuit can thus display a list of pupils (sorted alphabetically or using some other criterion or not sorted), and it can also display a plan of the classroom corresponding to the real positions of the pupils in the classroom (as communicated by the accelerometers of their tablets), which can be very practical for the teacher. This can enable the teacher to avoid creating a plan of classroom manually in the system. In addition, this represents the real situation, e.g. unexpected changes of position by certain pupils, e.g. in order to separate two pupils who argue or chatter too much. This also makes it possible to automatically take account of the creation of subgroups (with differentiated instruction, or subgroups defined arbitrarily in the context of a particular exercise). It may also happen that the children are sitting on the ground (e.g. in a library corner of the classroom) in an arrangement that cannot be predicted in advance. The system can also be used during music or plastic arts classes (or classes in the school library for familiarization with literature), or more generally courses that are being run not by the usual teacher of the class but by a specialist teacher (or a librarian, etc.), who may not know all of the pupils and in particular may not know the shyest pupils (especially when in charge of a very large number of pupils). In addition, such courses may take place in an environment different from the usual classroom (a music room, a plastic arts room, etc.) that may be fitted with its own electronic system for teaching assistance. The system may also be used by a replacement teacher who does not know the pupils in the class as well as the absent teacher does. Thus, obtaining a plan of the classroom automatically and dynamically can be extremely advantageous, with the information displayed on the teaching computer being usable immediately.

In an embodiment, the system comprises a docking station arranged to dock the plurality of wireless tablets (when they are not being used in class), and optionally serving to charge parallel the batteries of the tablets in parallel. This docking station may be arranged to reinitialize accelerometers of the tablets (and possibly reinitialize their gyros if they have them). The angle measurement given by a gyros and the position measurement given by an accelerometer are both obtained by integration, which means that errors accumulate and that inaccuracy in the measurements given (estimated angle or position along a given axis) increase with time. Gyros and accelerometers are initialized with their current attitude and position, and then they update their positions and attitudes by double integration of the accelerations they measure. The attitude (or orientation) designate the directions in three dimensions of three reference axes of an object relative to a rectangular frame of reference. This updating diverges over a certain amount of time (because small errors accumulate) and it can be necessary to give the accelerometers (or the gyros) their true positions (or attitudes). In an embodiment, it is assumed to a first approximation that when the tablets are in their docking station, they are situated at the same position and attitude, and all of the accelerometers (and gyros if they have them) are reinitialized to a single unique position (e.g. position (0,0,0) and a single unique attitude (e.g. 0,0,0)). This means that the inaccuracy in the measurement of the positions of the tablets is of an order of magnitude similar to the maximum distance between the two furthest-apart tablet docking ports (within the docking station), which is generally a distance that may be of the order of one meter. When the tablets include gyros, and when the gyros are reinitialized in the manner specified, it is necessary for the docking station to be arranged in such a manner that the attitudes of the tablets that are inserted therein are substantially identical (any error giving rise to inaccuracy in determining the attitudes of the tablets).

In an embodiment, reinitializing each accelerometer in each tablet takes account of the port in which that tablet is inserted, thereby eliminating the inaccuracy due to the approximation set out in the preceding paragraph. When a tablet is inserted in a port and is being charged, it is assumed that the position of that port is stationary relative to the docking station. The docking station is arranged to know the position and the attitude of each tablet charging in a given port (e.g. identified by a number of the port or by some other identifier) relative to the docking station. These positions and attitudes are defined when the docking station is designed and they are independent of the position and the attitude of the docking station itself

Thus, when the position and the attitude of a tablet being charged by a port are known, it is immediately possible to deduce the position and the attitude of the tablet charging in the other ports. The relative positions of the tablets constitute information that is sufficient (their absolute positions might potentially be useful, but in general they are not essential). Thus, the fact of not necessarily knowing the position and the attitude of the docking station itself is not a problem in this embodiment. The position of a tablet being charged by a port is entirely determined by the abscissa value, ordinate value, and height of a reference point of the tablet and the three-dimensional orientation of the tablet is fully determined by the yaw, roll, and pitching axes of the tablet. In an embodiment, it is only the abscissa and ordinate values of the tablet that matter. The various ports of the docking station may be spaced apart vertically and in a horizontal plane. For example, the docking station may have thirty-two stationary ports all having the same attitude and distributed in four columns, with two consecutive columns being horizontally spaced apart from each other by 25 centimeters (cm), two consecutive ports in a given column being vertically spaced apart by 12 cm. This is equivalent to saying that the docking station has eight rows of four ports each, that are vertically spaced apart from one another by 12 cm. Thus, reinitializing the accelerometers of the tablets may comprise setting the current abscissa values of the accelerometers by setting them to zero, setting the current ordinate values of the accelerometers by setting the ordinate values of tablets in the first column to zero, setting the current ordinate values of the accelerometers by specifying that the ordinate values of the tablets in the second column are 25 cm, setting the current ordinate values of the accelerometers by specifying that the ordinate values of the tablets in the third column are 50 cm, and setting the current ordinate values of the accelerometers by specifying that the ordinate values of the tablets in the fourth column are 75 cm. If the tablets are also identified in height, then the docking station can reinitialize accelerometers of the thirty-two tablets in the manner specified above, by also setting the current heights of the accelerometers by giving the tablets in the first row a height of zero, the tablets in the second row a height of 12 cm, and the tablets in row number n, where n lies in the range 3 to 8, as being equal to (n−1)×12 cm.

It is thus possible to represent all of the tablets on the screen in a frame of reference associated with the docking station, and to allow the teacher to apply any desired rotation to the display if the tablets are not oriented in the direction that seems the most intuitive. In an embodiment, the teaching computer comprises a teacher's laptop computer that may itself be charged by the docking station and that may include accelerometers (and optionally also gyros). This laptop computer may be displayed in a manner that differs from the display of the tablets (e.g. a different color and a larger size), thereby assisting the teacher in immediately identifying the teacher's own position in the plan of the classroom.

In an embodiment, the tablets include gyros, e.g. a respective gyro on each of three rotation axes. When the tablets are in the docking station, and when all of the ports have the same attitude with pitching and roll angles of zero in a frame of reference in which the vertical axis coincides with the vertical direction of the classroom, it is possible to reinitialize all three gyros (as well as the accelerometers) in each tablet by setting the angles delivered by each of the three gyros to zero. In contrast, if the ports slope downwards so as to enable the tablets to slide towards a stable position at the bottom of the port under gravity (in order to be charged), it is possible to set the value of the pitching angles to the value of this angle of inclination of the port (which is set by construction of the docking station), while leaving the roll and yaw angles at zero.

In another embodiment, the docking station is organized differently, but the position and the attitude of each of the tablets inserted therein are stationary relative to the position and the attitude of the docking station, as above. For example, the docking station may have ports arranged along superposed circular arcs. It is possible for each port to store the six parameters constituted by the yaw, roll, and pitching angles and the three coordinates (possibly corresponding to the coordinates of the center of gravity of the tablet) for a tablet loaded into the port, in the frame of reference of the docking station. The accelerometers and the gyros of each of the tablets are each reinitialized by setting their values as being equal to the six parameters associated with the port in which the tablet is loaded (i.e. the three coordinates and the three angles).

In an embodiment, the docking station is movable (e.g. mounted on casters). Under such circumstances, and without additional provisions (such as those described below), the teacher needs to be informed that all of the tablets must be stored simultaneously in the station for the purposes of reinitializing their accelerometers and/or gyros (and possibly for storage and/or for recharging their batteries), or at least that the docking station must not be moved until the accelerometers and the gyros of all of the tablets have been reinitialized (unless they are reinitialized again when the docking station is in its new position). In practice, it can be assumed that reinitialization is performed at least once per day (at the end of the day, the tablets are typically all stored and being charged). Reinitialization may be automatic. It is advantageous for it to be performed at the time the tablet is extracted from the docking station (or at least as late as possible before being taken therefrom), so as to be as up to date as possible (with minimized drift). For this purpose, as soon as a tablet has been inserted in the docking station, reinitialization may take place continuously so long as the tablet has not been extracted. Alternatively, reinitialization may be performed once every minute (or at some other rate) once the tablet has been inserted in the docking station and until it is extracted therefrom. Reinitialization may also be manual, on an instruction from the teacher using the teaching computer.

In another embodiment, the docking station may itself be provided with a set of accelerometers and gyros enabling it to know its own position. It is useful for the docking station to have at least two accelerometers and at least one gyro. An accelerometer along the vertical axis is generally superfluous since the docking station will not normally change its altitude (will not normally be raised or lowered) while it is in a classroom (unless the classroom includes a lower portion or a higher portion accessible to the docking station). In contrast, it is possible to use more than two accelerometers in the horizontal plane in order to improve measurement quality, e.g. the station may have four accelerometers. It is also possible to provide redundant accelerometers (e.g. each of the four accelerometers may be duplicated) in order to provide a high degree of reliability (e.g. in the event of an accelerometer failing). In this embodiment, the station includes at least one gyro on the vertical axis. Gyros on the other two axes representing pitching and roll are not generally pertinent since the floors in classrooms are generally flat and any pitching or rolling can generally be excluded. Nevertheless, certain inertial units may be provided by default with gyros on all three possible axes and it may be appropriate to use them even when measurements from two gyroscopes are not necessarily very pertinent. In a possible embodiment, it is possible to use a plurality of gyros for redundancy purposes and/or in order to improve the quality with which the angle giving the orientation of the docking station is measured relative to a vertical axis (yaw angle). It is advantageous to measure this angle since the relative positions of the tablets are affected not only by the frame of reference of the docking station moving in translation, but also by its frame of reference turning through a yaw angle.

Instead of (or as well as) reinitializing the accelerometers (and the gyroscopes if any) of the tablets, such a docking station may synchronize them. That is say instead of copying the six constant parameters associated with each port into the respective registers of the three accelerometers and the three gyros of the tablet inserted in the port, the station uses these six parameters, but corrects them to take account of the position and the attitude of the station. It thus performs a change of frame of reference, going from the frame of reference of the station to the frame of reference of the classroom. As mentioned above, it is possible to use fewer than six parameters, e.g. it is possible to use only two parameters (abscissa and ordinate values) in the tablet and to update them while using only three parameters of the docking station (its abscissa and ordinate values and its yaw angle). The station may simultaneously synchronize and reinitialize the accelerometers and the gyros of each tablet, by providing two registers for each accelerometer and for each gyro of each tablet. One series of registers thus makes it possible for the tablet to know its position and attitude in a frame of reference of the docking station, and another series enables it to know them in a frame of reference of the classroom.

By means of these provisions, the teacher can put tablets into the docking station for charging in non-simultaneous manner and regularly move the docking station without that interfering with the mechanism for synchronizing the accelerometers and gyros of the tablets, since any movement of the docking station is taken into account as a result of changing the frame of reference. Nevertheless, it is appropriate to ask teachers not to extract a tablet from the docking station while it is moving, or by default to synchronize the tablets continuously or with a refresh interval that is very short. The interval of one minute proposed above in one embodiment for reinitialization is too long to be transposed to synchronization under such circumstances, since the docking station can be moved substantially in only a few seconds.

In principle, the drift of the accelerometers and of the gyro(s) in the docking station matters little, insofar as the drift is sufficiently slow to be of little significance over a period of time needed for synchronizing all of the tablets. For example, it is possible to assume that the tablets are used shortly after being extracted from the docking station, and that in any event they are stored and recharged and thus synchronized at least once per day. Drift over the duration of a school day (i.e. about eight hours, generally from 8:30 AM to 4:30 PM) can be considered to be of little importance, and would be manifest in the event of one tablet being extracted from the docking station at 8:30 AM, and another at 4:29 PM, with both of them being used during the last minute of the school day. Under such circumstances, the relative positions of those two tablets (as indicated by their respective accelerometers and gyros) would be distorted by the sum of the drift between 8:30 AM and 4:29 PM of the accelerometers and the gyros of the tablet extracted at 8:30 AM and of the accelerometers and gyros of the docking station.

The above embodiment in which the docking station performs synchronization continuously or at very short intervals (while the tablets are in the station) serves to manage problems associated with drift without the teacher even being aware that such problems exist. The teacher can thus move the docking station freely at any moment, and can charge the tablets in non-simultaneous manner, it being understood that the running time of each tablet in any event requires it to be recharged periodically, thus enabling it to be resynchronized periodically.

Nevertheless, a system for reinitializing the accelerometers and the gyros of the docking station could also be arranged to avoid drift becoming so great as to lead to undesirable side effects, for example. By way of example, one accelerometer may drift faster than another, and after a certain length of time may give a value that is capable of overflowing the size of a register, or rounding errors giving rise to inaccuracies on the estimated positions. For example, if one accelerometer initialized to zero has drifted by ten kilometers after a few years, the measurements delivered by that accelerometer will lie in a range of several meters around ten kilometers. In one possible use, the classroom measures fifteen meters and it is desired to obtain measurements that are accurate to within about ten centimeters. The accelerometer would than return a position lying in the range approximately 10,000.0 meters (m) to 10,015.0 m, i.e. the measurement accuracy of interest (accuracy to within 10 cm) represents about one hundred thousandth of the measurement returned. If it is desirable to calculate a distance, it may be necessary to square the measurement, and the accuracy of measurement of interest then represents one ten-billionth of the square of the measurement returned, which can give rise to rounding errors having a large effect on accuracy. In order to remedy that risk, it is possible to work on registers of very large size providing immunity against rounding errors, but that may turn out to be very constraining and to reduce performance, while complicating portability of the software and updating of the software (in a software implementation). Alternatively, as soon as the docking station detects that all of the tablets are inserted simultaneously, it may reinitialize its own accelerometers and gyros to zero, and reinitialize the accelerometers and the gyros, if any, of the tablets by using the six values associated with each port (or using any other one of the above-described reinitialization methods). This situation (simultaneous presence of all of the tablets) is not necessarily very frequent, since a tablet can often be forgotten in a locker or under a table. Nevertheless, it can be assumed that it happens at least once per month, approximately, which may be sufficient. Otherwise, on observing a large amount of drift on at least one of its own accelerometers, or in the event of no reinitialization being performed for a duration longer than a given threshold (e.g. one month or any suitable value), the docking station may send a message to the teaching computer. A large amount of drift may be considered as being observed when the position given by one accelerometer gives a value that is clearly outside the classroom, e.g. a value of more than one hundred meters when the accelerometer was initialized to zero on being installed in the classroom. The message sent to the teaching computer may display a window requesting the teacher as soon as possible (e.g. after the class) to put all of the tablets into the docking station in order to proceed with complete reinitialization of the accelerometers and gyros of the station and the accelerometers and gyros of the tablets. In another embodiment, instead of sending a message requesting the teacher to put all of the tablets in the docking station, the station may wait until the number of tablets simultaneously present in the station exceeds a certain threshold (e.g. 85% of the tablets). This generally occurs sufficiently often (generally once per day, whenever the tablets are stored after class). The station then proceeds to reinitialize the accelerometers and gyros of all of the tablets while at the same time reinitializing the accelerometers and gyros of the docking station. This operation can have the effect of completely desynchronizing those tablets that were not in the docking station (even though this is not necessarily the case after a period of one month or some other period that has triggered the operation, since it is theoretically possible that there has not been any significant drift, even if that is not very probable). This desynchronization relates to no more than 15% of the tablets if the threshold is set at 85%. These desynchronized tablets may all of a sudden appear to be located virtually at a distance from the other tablets that is absurd (according to the indications from their own accelerometers and gyros). In an embodiment, the docking station marks these tablets as being tablets that are desynchronized, and notifies the teaching computer. In an embodiment, the docking station is managed by the teaching computer, since they are both the same computer (in which case no notification is necessary). In a variant, the teaching computer has a computer for the teacher and a physical server, and it is the physical server that provides complete management of the docking station. Whatever the situation, the teaching computer can then group together the desynchronized tablets (or potentially desynchronized tablets). This group of tablets, or at least the subgroup of those tablets that are being used by pupils in the class, may be displayed on the screen. This subgroup can be displayed in arbitrary order, or in alphabetical order of the names of the pupils concerned. The desynchronized tablets may also be displayed separately depending on their relative positions. Their relative positions may be determined on the basis of desynchronized (or potentially desynchronized) position information from their respective accelerometers and gyros. They are desynchronized or potentially desynchronized only relative to the tablets that have been reinitialized, however relative to one another they should in theory still be substantially synchronized. The teaching computer can display an indication on the screen to inform the teacher that the positions of these few tablets are uncertain and that it is desirable for them to be resynchronized by being inserted for at least a few seconds in the docking station so that they can be displayed together with the others. In any event they are to be resynchronized as soon as their batteries run down (since they then need to be reinserted in the docking station in order to be charged) or as soon as they are stored in the docking station (e.g. a the end of the day after the courses, independently of any need to charge batteries).

In an embodiment, the electronic system for providing assistance in teaching is arranged so that the educational content includes (at least) a portion associated with a tag specifying an expected frequency of touch interaction. The predetermined threshold from which a warning is sent to the teaching computer in the event of inaction is then a function of the tag.

Thus, certain exercises can require more thought than input, e.g. reading a long text, prior to answering questions, whereas other exercises may be exercises involving an immediate reaction, as with mental calculation exercises. An educational content may correspond to a session during which the level of interactivity with the pupil fluctuates. Thus, a first portion may be associated with a first expected frequency of interaction, a second portion with a second expected frequency of interaction, and it is thus possible to provide as many portions as necessary. For a mental calculation exercise, it is possible that the expected frequency of interaction to be of the order of 0.33 Hz, i.e. for the pupil to be expected to reply to one question every three seconds on average (clearly other values are possible, in particular depending on the age of the pupils). Nevertheless, the fact that a tablet remains inactive for three seconds is not necessarily sufficient to trigger the sending of a warning. A first threshold (e.g. corresponding to displaying a yellow icon) may for example be set at a first duration, e.g. one minute, during which the mean interaction frequency remains X times lower (e.g. five times lower) than the expected frequency. A second threshold (e.g. corresponding to a red icon) may for example be set at a second duration (e.g. five minutes) during which the mean frequency of interaction remains Y times lower (e.g. likewise five times lower, or possibly more, e.g. ten times lower) than the expected frequency.

All of these thresholds may be set by default and may be adjustable by the teacher with the teaching computer.

In an embodiment, an electronic system for providing assistance in teaching has a teaching computer arranged to virtualize the environment of each wireless tablet (e.g. with a type 1 or type 2 hypervisor) and thus manage the display of educational content on behalf of each wireless tablet (and on the screen of each wireless tablet), while also processing the touch input made on the wireless tablet. Each tablet can access the virtualized environment via virtual network computing (VNC) that enables the screen to be remote and that enables mouse inputs to be seen using the RFB protocol (where a stylus may be handled in certain embodiments as though it were a mouse). It is also possible to use other protocols such as ICA or RDP.

The teaching computer may comprise a computer with a graphics interface (which computer may be a laptop or other computer) that is used by the teacher, together with a physical server that is distinct and that is used in particular for virtualizing the tablets. Alternatively, the teaching computer is a personal computer (which may be a laptop or other computer).

In an embodiment, the wireless tablets may be of limited capacity (being limited essentially to receiving information for display, and to sending the touch inputs so that they can be processed by the teaching computer). All of the information input by the tablets can thus be stored on the teaching computer (and in particular on its server, if it has one). The server may include data redundancy mechanisms such as a redundant array of independent disks (RAID) in order to ensure the integrity of the data, or it might have a power supply backed up by an inverter, so that integrity is thus better than that provided by a conventional tablet. The calculation power of such a server may also be considerably greater than the combined power of the tablets of the class and may provide greater user comfort. The tablets may be all identical, i.e. completely interchangeable. At any moment, a pupil can thus put down a faulty or discharged tablet and take another tablet, become recognized by the identification circuit of the tablet, and continue working from where the work was left off, given that the work is virtualized in the server.

FIG. 2 shows a method in a particular implementation. The method involves tablets T1, T2, . . . , TN, and a portable computer PC, a server SRV, and a supervision circuit SV.

The tablets T1, T2, . . . , TN are virtualized on the server SRV.

During a first step CONT, the server SRV sends content to the tablets (which content may be different for each tablet). During a later step, a pupil using one of the tablets makes a touch input on the tablet. This input is then transmitted during a step INPUT by the tablet to the server SRV.

Automatically, the supervision circuit is notified of this input (when it is received by the server SRV) and requests the server SRV to store it in a file associated with the pupil in question.

Later, the teacher uses the teacher's laptop computer PC to request the supervision circuit SV to play back the pupil's session, during a step PB1. The supervision circuit SV informs the server SRV of this request during a step PB2. The server SRV responds to this request during a step PB3 by playing back the content transmitted to the pupil and also the inputs made by the pupil.

In an embodiment, a method of providing electronic assistance in teaching is performed using a system comprising:
a plurality of wireless touch tablets each having a user identification circuit;
a teaching computer storing a list of pupils and arranged to transmit educational content to each wireless touch tablet for which the user has been identified as a pupil in the list; and
a supervision circuit.

The method comprises the supervision circuit storing the touch inputs made via all of the wireless touch tablets having users that have been identified as pupils in the list of pupils. Storage takes place in respective files associated with the pupils, the files containing the spatial coordinates of each touch input in question as well as a time marker specifying the instant at which the touch input occurred.

In response to a request from the teaching computer, the method comprises playing back the educational content transmitted to the touch tablet used by a given pupil in the list of pupils, and simultaneously playing back the results of the touch inputs made on the touch tablet (while the pupil was accessing the educational content).

In an embodiment, when the supervision circuit stores an insufficient number of pertinent touch inputs for the given wireless touch tablet over a duration longer than a predetermined threshold, the method of providing electronic assistance in teaching includes the supervision circuit notifying the teaching computer of this event of there being insufficient pertinent touch inputs.

In an embodiment, the educational content includes a portion associated with a tag indicating an expected frequency of touch interaction, and the predetermined threshold is a function of the tag.

In an embodiment, a method of providing electronic assistance in teaching includes a teaching computer that is arranged to virtualize the environment of each wireless tablet and thus to manage the display of the educational content on behalf of each wireless tablet, and also to process the touch inputs made on the wireless tablet.

In an embodiment, a computer program comprises a series of instructions performing the method of one of the implementations when the instructions are executed by one or more processors. The program may, in particular, be written in assembly language, in C, in Java, in C#, or in any other appropriate language. The language may be different for a program portion situated in a tablet and for a program portion situated in the teaching computer or in the supervision circuit when the supervision circuit is distinct.

In an embodiment, a non-transitory computer-readable storage medium stores a program as set out in the paragraph above. The storage medium may be a rewritable memory (e.g. of the electrically erasable programmable read-only memory (EEPROM) or flash memory type or of the battery-backed-up random access memory (RAM) type) or it may be non rewritable memory (e.g. memory of the read-only memory (ROM) type). The memory may be integrated in a tablet, either directly on its motherboard, or in the form of a memory card (such as a micro-SD or other card). The storage medium may also be a magnetic medium of the hard disk type (possibly incorporated within a teaching computer).

The embodiments of the present invention is not limited to the embodiments described above by way of example; it extends to other variants.

Certain improvements are independent of one another, e.g. the docking station with means for synchronizing the accelerometers (and gyros if any) of the tablets may be used independently of the other aspects of the present invention. It is possible to devise solutions constituting alternatives to accelerometers (e.g. triangulation based on transmitters arranged in the classroom and receivers installed in the tablets, which this solution is less flexible in use and more complex to install but can be more accurate and has substantially no drift).

Implementations relating to the methods may be transposed to the systems, and vice versa.

1-10. (canceled)

11. An electronic system for providing assistance in teaching, the system comprising:
a plurality of wireless touch tablets each having a user identification circuit;
a teaching computer storing a list of pupils, and arranged to transmit educational content to each wireless touch tablet for which the identified user is a pupil of the list; and
a supervision circuit arranged to store the touch inputs made on all of the wireless touch tablets for which the identified user is a pupil of the list of pupils, which touch inputs are stored in respective files associated with the pupils, the files containing the spatial coordinates of each touch input under consideration as well as a time marker indicating the instant of the touch input, and arranged to respond to a request from the teaching computer by playing back the educational content transmitted to the touch tablet used by a given pupil in the list of pupils, while simultaneously playing back the results of the touch inputs made on the touch tablet.

12. The system according to claim 11, wherein the supervision circuit is arranged, in the event of it storing an insufficient number of pertinent touch inputs for a given wireless touch tablet over a duration longer than a predetermined threshold, to notify the teaching computer of this event of insufficient pertinent touch inputs.

13. The system according to claim 12, wherein the educational content includes a portion associated with a tag indicating an expected frequency of touch interactions, and wherein the predetermined threshold is a function of the tag.

14. The system according to claim 11, wherein the teaching computer is arranged to virtualize the environment of each wireless tablet and to manage the display of the educational content on behalf of each wireless tablet, and also to process the touch inputs made on the wireless tablet.

15. The system according to claim 12, wherein the teaching computer is arranged to virtualize the environment of each wireless tablet and to manage the display of the educational content on behalf of each wireless tablet, and also to process the touch inputs made on the wireless tablet.

16. The system according to claim 13, wherein the teaching computer is arranged to virtualize the environment of each wireless tablet and to manage the display of the educational content on behalf of each wireless tablet, and also to process the touch inputs made on the wireless tablet.

17. A method of providing electronic assistance in teaching with a system comprising:
a plurality of wireless touch tablets each including a user identification circuit;
a teaching computer storing a list of pupils and arranged to transmit educational content to each wireless touch tablet for which the user has been identified as a pupil of the list; and
a supervision circuit;
the method comprising:
a) the supervision circuit storing touch inputs performed on every wireless touch tablet which user is identified as a pupil of the list of pupils, which touch inputs are stored in a respective file associated with the pupil, the file containing the spatial coordinates of each touch input under consideration as well as a time marker indicating the instant of the touch input; and
b) on request from the teaching computer, playing back the educational content transmitted to the touch tablet used by a given pupil of the list of pupils, and simultaneously playing back the result of the touch inputs performed on the touch tablet.

18. The method according to claim 17, including, in the event of the supervision circuit storing an insufficient number of pertinent touch inputs for a given wireless touch tablet over a duration greater than a predetermined threshold:
c) the supervision circuit notifying the teaching computer of this event of insufficient pertinent touch inputs.

19. The method according to claim 18, wherein the educational content includes a portion associated with a tag indicating an expected frequency of touch interactions, and wherein the predetermined threshold is a function of the tag.

20. The method according to claim 17, wherein the teaching computer is arranged to virtualize the environment of each wireless tablet and to manage the display of the educational content on behalf of each wireless tablet, and also to process the touch inputs made on the wireless tablet.

21. The method according to claim 18, wherein the teaching computer is arranged to virtualize the environment of each wireless tablet and to manage the display of the educational content on behalf of each wireless tablet, and also to process the touch inputs made on the wireless tablet.

22. The method according to claim 19, wherein the teaching computer is arranged to virtualize the environment of each wireless tablet and to manage the display of the educational content on behalf of each wireless tablet, and also to process the touch inputs made on the wireless tablet.

23. A computer program including a series of instructions performing the method according to claim 17 when the instructions are executed by one or more processors.

24. A computer program including a series of instructions performing the method according to claim 18 when the instructions are executed by one or more processors.

25. A computer program including a series of instructions performing the method according to claim 19 when the instructions are executed by one or more processors.

26. A computer program including a series of instructions performing the method according to claim 20 when the instructions are executed by one or more processors.

27. A non-transitory computer-readable storage medium comprising a computer program according to claim 13.

28. A non-transitory computer-readable storage medium comprising a computer program according to claim 24.

29. A non-transitory computer-readable storage medium comprising a computer program according to claim 25.

30. A non-transitory computer-readable storage medium comprising a computer program according to claim 26.
